(19) United States
(12) Patent Application Publication
(10) Pub. No.: US 2005/0015990 A1
(43) Pub. Date: Jan. 27, 2005

(54) Method for producing a shaving aid cartridge

(76) Inventors: Chris A. Barone, Trumbull, CT (US); Donald P. Roche, Orange, CT (US)

Correspondence Address: McCormick, Paulding & Huber LLP;CityPlace II, 185 Asylum Street, Hartford, CT, 06103, US

(21) Appl. No.: 10/626,989

(22) Filed: Jul. 25, 2003

(51) Int. Cl. B26B 19/44

(52) U.S. Cl. 30/41

(57) ABSTRACT

A method for producing a shaving aid cartridge is provided. The method includes the steps of forming a base having features operable to attach the cartridge to a razor assembly, and forming a shaving aid body that is attached to the base during the forming of the shaving aid body.

### BACKGROUND OF THE INVENTION

1. Technical Field

The present invention relates to methods for producing shaving apparatus in general, and to methods for producing shaving aid cartridges in particular.

2. Background Information

Conventional safety razors typically include a disposable razor cartridge mounted in a reusable handle, or a handle and cartridge combined into a unitary disposable unit. Most razor cartridges include a frame, at least one razor blade, and a strip of shaving aid material attached to the frame. Shaving aid materials include, but are not limited to lubricating agents, drag reducing agents, depilatory agents, cleaning agents, medicinal agents, and the like that enhance the shaving process. The strip of shaving aid material is typically attached to the cap of the razor cartridge.

Most safety razors are designed for use with a shaving preparation. The shaving preparation (e.g., shaving cream) is applied to the skin and remains there until it is removed during the shaving process, or washed off thereafter. Although shaving preparations desirably enhance the shaving process, they also have undesirable aspects. For example, shaving cream is impractical in a wet shaving environment because the shaving cream is often washed away before the shaving process can be completed. In addition, shaving cream is an item independent of the razor that must be purchased and stored by the user; i.e., one more item to store in the bathroom.

Razor systems designed to provide a shaving preparation in a desirable manner in a wet shaving environment are disclosed in U.S. patent application Ser. Nos. 09/505,408 and 10/367,255, commonly assigned with the present application, and hereby incorporated by reference. The razor systems include a handle, a razor cartridge, and a shaving aid body. In each of these razor systems, the shaving aid body is typically oval shaped body that has a center aperture sized to receive the razor cartridge. The shaving aid body includes a material that erodes during the shaving process.

The present invention relates to methods for producing such a shaving aid body and similar articles.

### DISCLOSURE OF THE INVENTION

According to the present invention, a method for producing a shaving aid cartridge is provided. The method includes the steps of forming a base having features operable to attach the cartridge to a razor assembly, and forming a shaving aid body that is attached to the base during the forming of the shaving aid body. The base and the shaving aid body are preferably formed sequentially using mold portions that engage one another. The forming of the shaving aid body includes injecting shaving aid material in a flowable form into a closed mold containing the base. After the appropriate amount of shaving aid material is injected into the mold, the body is solidified thereby attaching the base and body together to form the shaving aid cartridge.

An advantage of the present invention is that a method is provided for producing a shaving aid cartridge that includes a base having features operable to attach the cartridge to a razor assembly, and a body of erodable shaving aid material. The base enables the shaving aid cartridge to be attached to a razor assembly and the erodable shaving aid material provides a mechanism through which shaving aid material can be dispensed in a favorable manner in a wet shave environment.

The embodiment of the present method wherein shaving aid material is injected into a mold containing a base provides several additional advantages. First, the use of injection techniques allows for a precise volume of shaving aid material to be disposed into the closed mold. The need to remove excess shaving aid material to achieve the final configuration is therefore greatly reduced or eliminated. The amount of scrap shaving aid material is therefore reduced.

Second, the injection process enables the shaving aid cartridge to be formed in a sequential (i.e., a “multiple-shot”) process. The base can be formed in a first mold and subsequently placed in a second mold where the shaving aid material is injected to collectively form the shaving aid cartridge. Consequently, a single item consisting of two elements, each element having significantly different material properties, can be manufactured in a single process on a single machine. The ability to manufacture the shaving aid cartridge on a single machine also greatly reduces the amount of time and handling that would be required to produce the same cartridge in a multiple step process. Minimizing the amount of handling required to manufacture the shaving aid cartridge is significant because the shaving aid material is easily deformed.

Third, injection techniques generally improve the dispersion of the shaving aid material throughout the mold; i.e., into those areas where shaving aid material is desired and out of those areas where shaving aid material is not desired. The attachment between the base and the shaving aid body is consequently facilitated. For example, the base includes features that facilitate attachment between the base and the shaving aid body, and features operable to attach the cartridge to a razor assembly. It is desirable to have shaving aid material dispersed in and around those features that facilitate attachment between the base and the shaving aid material. It is not, however, desirable to have shaving aid material dispersed in and around those features operable to attach the cartridge to a razor assembly. The injection process facilitates providing shaving aid material only where it is desired.

Fourth, using an injection technique to produce a shaving aid cartridge enables multiple elements to be combined with improved structural integrity. For example, a shaving aid body can be formed integral with a base that has features designed to attach the shaving aid body, and other features for attaching the shaving aid cartridge to a razor assembly.

These and other objects, features, and advantages of the present invention will become apparent in light of the detailed description of the present invention.

### BRIEF DESCRIPTION OF THE DRAWINGS

FIG. 1 is a side view of a razor assembly including the shaving aid cartridge.

FIG. 2 is a perspective view of a shaving aid cartridge.

FIG. 3 is a perspective view of a base embodiment for a shaving aid cartridge.

FIG. 4 is a perspective view of the base embodiment shown in FIG. 3, shown from the opposite side.

FIG. 5 is a perspective view of a base embodiment for a shaving aid cartridge.

FIG. 6 is a perspective view of a base embodiment for a shaving aid cartridge.

FIG. 7 is a diagrammatic illustration of a forming apparatus, wherein a base and the shaving aid body are formed within molds.

FIG. 8 is a enlarged view of a portion of the diagrammatic illustration shown in FIG. 7

### DETAILED DESCRIPTION OF THE INVENTION

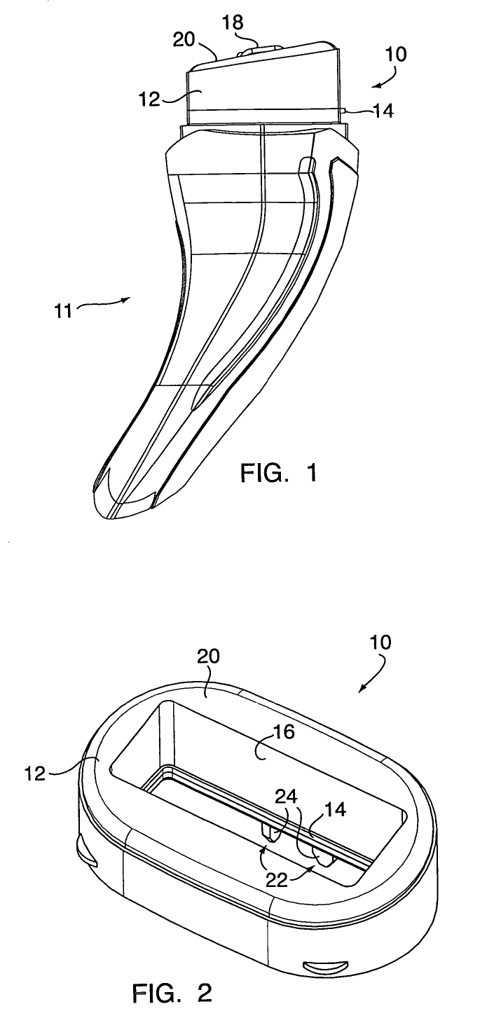

Referring now to FIGS. 1 and 2, a shaving aid cartridge 10 for use with a razor assembly 11 includes a shaving aid body 12 and a base 14. The shaving aid body 12 includes a centrally located aperture 16, sized to receive a razor cartridge 18. The upper surface of shaving aid body 12 defines a contact surface 20 for engagement with the surface to be shaved. The shaving aid body 12 shown in FIGS. 1 and 2 is a single oval having a center aperture 16. In alternative embodiments, the shaving aid body 12 can comprise one or more sections adjacent the center aperture 16; e.g., a forward portion, an aft portion, and/or side portions. The cross-sectional geometry of the shaving aid body 12 is typically oval-shaped, but is not limited to an oval shape.

The shaving aid body 12 consists of an erodable shaving aid material. Shaving aid materials include, but are not limited to, lubricating agents, drag reducing agents, depilatory agents, cleaning agents, medicinal agents, soap, and the like that enhance the shaving process. In a preferred embodiment, the shaving aid material includes a soap. In some applications, the soap may include synthetic detergents. The shaving aid material 12 is substantially or completely water-soluble. The rheological characteristics of the shaving aid material are selected so that the shaving aid body can be formed in the manners described below. The shaving aid body 12 erodes during normal use, thereby applying shaving aid material to the surface to be shaved.

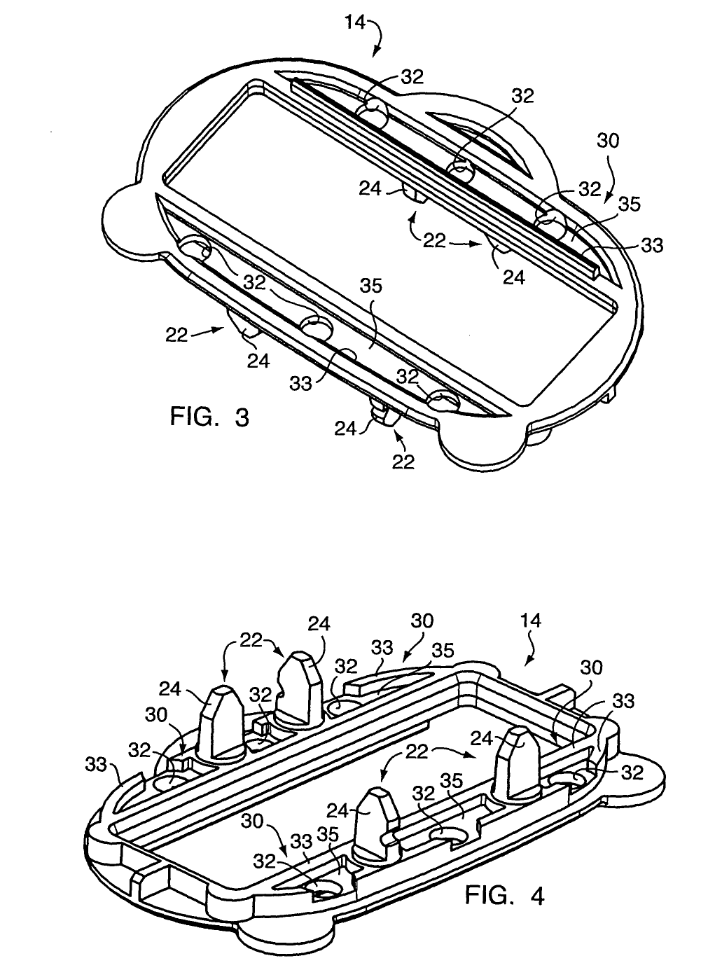

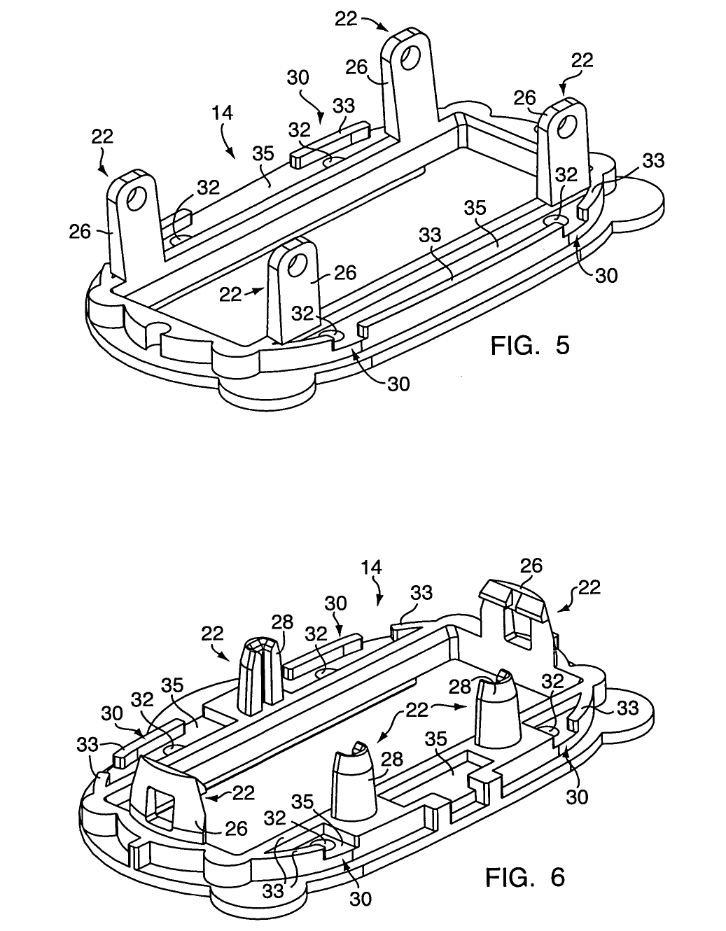

Referring now to FIGS. 3-6, the base 14 is a substantially rigid structure that includes features 22 operable to attach the shaving aid cartridge 10 to a razor assembly 11. The features 22 operable to attach the shaving aid cartridge 10 to the razor assembly 11 include tabs, flanges, or the like that enable the shaving aid cartridge to be mechanically attached to a razor assembly. FIGS. 3 and 4 show a base 14 having a plurality of tabs 24. FIG. 5 shows a base 14 having a plurality of flanges 26 with apertures. FIG. 6 shows a base 14 having a plurality of flanges 28 with slots, and a plurality of flanges 26 with apertures. The type and configuration of the features 22 operable to attach the shaving aid cartridge 10 to a razor assembly 11 can be varied to fit the application at hand. The base 14 typically further includes features 30 operable to attach the shaving aid body 12 to the base 14. The features 30 for attaching the shaving aid body 12 to the base 14 may include, for example, one or more apertures 32, protrusions 33, and/or voids 35 which the shaving aid material flows within and around during the forming step. The apertures 32, protrusions 33, and/or voids 35 are preferably configured and positioned such that during formation of the shaving aid cartridge 10, the shaving aid body 12 and base 14 are fixed to one another by the shaving aid material solidified within and around the apertures 32, protrusions 33, and/or voids 35 within the base 14. The process of attaching the base 14 and shaving aid body 12 to one another is described in more detail below. The base 14 preferably, but not necessarily, consists of a thermoplastic material.

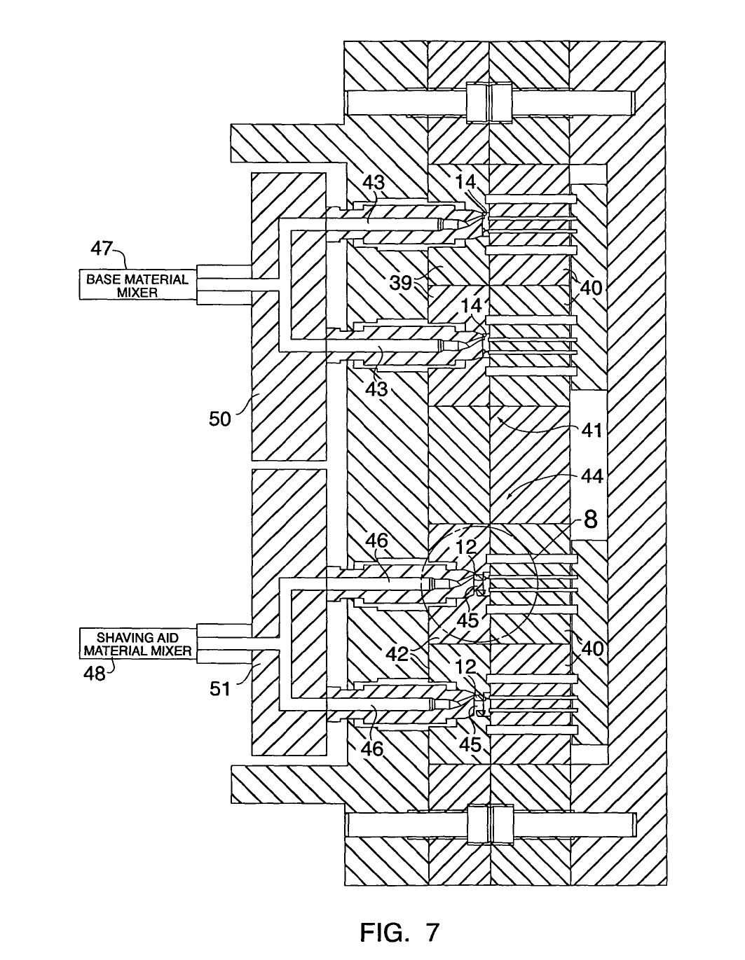

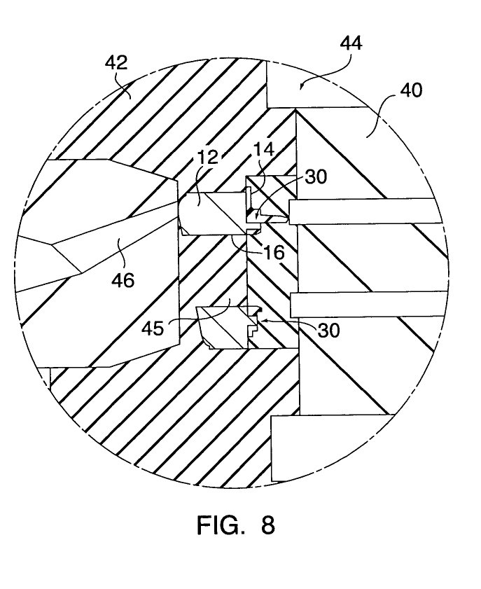

Referring to FIGS. 7 and 8, the forming of the shaving aid body 12 includes a sequential (or “multiple-shot”) injection process for forming the shaving aid cartridge 10. The injection process utilizes at least a first mold 41 and a second mold 44. In most production environments, a plurality of products are formed at once; i.e., a plurality of first molds 41 and second molds 44. The process is described below in terms of a pair of first molds 41 and a pair of second molds 44 for convenience sake only, but could be any number of first molds 41 and second molds 44.

The first mold 41 includes a base portion 39 and a common portion 40. The second mold 44 includes a shaving aid body base portion 42 and the common portion 40. In a first shot, thermoplastic material at a temperature of about four hundred degrees Fahrenheit (400° F.) processed in a mixer 47 is injected into the first mold 41 via a manifold 50 and a probe 43 to form the base 14. Once the thermoplastic material is sufficiently solidified, the common portion 40 of the first mold 41 is manipulated (e.g., rotated) and engaged with the shaving aid body portion 42 to collectively form the closed second mold 44. In a second shot, shaving aid material in a flowable form, at a temperature of about one hundred to one hundred and fifteen degrees Fahrenheit (100° F.-115° F.) is injected through a probe 46 into the closed second mold 44 to form the shaving aid body 12. In alternative embodiments, the multiple-shot process may include more than two shots.

The shaving aid material is typically processed through the use of a screw-type mixer 48 (shown diagramatically) that shears the raw material, consequently adding energy to, and mixing, the raw materials to produce the flowable material. It is our experience that it is beneficial to cool the material being mixed by cooling the mixer 48 to maintain the flowable material in the desired temperature range. In a preferred arrangement, a manifold 51 is disposed between the mixing device 48 and the second mold 44. The manifold 51 contains passages that distribute the flowable shaving aid material to the probes 43,46. The region adjacent the probes 46 extending out of the manifold 51 may be heated to maintain the flowable shaving aid material at a desirable temperature. The shaving aid body portion 42 of the second mold 44 that provides the shaving aid body its contour is preferably cooled to a temperature at or below the solidification temperature of the shaving aid material.

During the injection process, shaving aid material flows within or around features 30 attached to or formed within the base 14 as described above, but not in or around the features 22 operable to attach the shaving aid cartridge 10 to the razor assembly 11. The shaving aid material that flows within and around the apertures 32, protrusions 33, and voids 35 (see FIGS. 3-6) prevents the base 14 and shaving aid body 12 from being separated from one another under conditions normal to the shaving process. The shaving aid material also flows around a centrally located member 45 to create the center aperture 16 of the shaving aid body 12. The mold portions 40,42 remain engaged with one another until the shaving aid material has sufficiently solidified, so that the shaving aid body 12 and base 14 can be removed from the mold as the shaving aid cartridge 10.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims. For example, although the above description is directed toward a shaving aid cartridge, it should be understood by those of skill in the art that aspects of the above-described method may be used to produce articles other than the shaving aid cartridge described.

1. A method for producing a shaving aid cartridge, comprising the steps of:
forming a base having features for attaching the shaving aid cartridge to a razor assembly; and
forming a shaving aid body attached to the base during the forming of the shaving aid body.

2. The method of claim 1, wherein the base comprises a thermoplastic material.

3. The method of claim 2, wherein the shaving aid body comprises an erodable material.

4. The method of claim 3, wherein the shaving aid body comprises a soap material.

5. The method of claim 1, wherein the step of forming of the shaving aid body comprises the step of injecting a shaving aid material in a flowable form into a closed mold containing the base.

6. The method of claim 5, wherein the shaving aid body comprises an erodable shaving aid material.

7. The method of claim 6, wherein the shaving aid material comprises a soap material.

8. The method of claim 1, wherein the step of forming the base comprises the step of injecting a thermoplastic material into a first mold.

9. The method of claim 8, wherein the step of forming of the shaving aid body occurs after the step of forming the base, and comprises the steps of:
disposing the base within a closed second mold; and
injecting a shaving aid material in a flowable form into the second mold.

10. The method of claim 9, further comprising the step of cooling at least a portion of the second mold.

11. A method for shaving aid cartridge, comprising the steps of:
injecting a thermoplastic material into a closed first mold to form a base, the first mold including a base portion and a common portion;
engaging the common portion of the first mold with a shaving aid body portion to form a closed second mold, wherein the base remains with the common portion and is disposed within the second mold;
injecting a shaving aid material into the second mold to form a shaving aid body; and
removing the shaving aid cartridge that includes the base coupled to the shaving aid body from the second mold.

12. The method of claim 11, further comprising the step of cooling at least a portion of the shaving aid body portion of the second mold.

13. The method of claim 12, wherein the at least a portion of the shaving aid body portion of the second mold is cooled to a temperature below a solidification temperature of the shaving aid material.

14. The method of claim 11, wherein the common portion includes voids shaped to form features operable to attach the shaving aid cartridge to a razor assembly.

15. The method of claim 14, wherein the shaving aid material is processed into a flowable state using a screw type mixer.

16. The method of claim 15, wherein at least a portion of the screw type mixer is cooled during the processing of the shaving aid material.

17. The method of claim 11, wherein the shaving aid material erodable in a water environment.

18. The method of claim 17, wherein the shaving aid material comprises a soap material.
